(19) United States
(12) Patent Application Publication
(10) Pub. No.: US 2019/0112755 A1
(43) Pub. Date: Apr. 18, 2019

(54) SYSTEMS AND METHODS FOR CHARGING BASE STATION FOR DC CARPET SEAMING IRON

(71) Applicant: TTI (MACAO COMMERCIAL OFFSHORE) LIMITED, Macau (MO)

(72) Inventors: Casey R. Izard, Easley, SC (US); Tanmay Kavathekar, Central, SC (US); Samuel Boyles, Easley, SC (US)

(21) Appl. No.: 15/783,844

(22) Filed: Oct. 13, 2017

(51) Int. Cl. D06F 79/02; H02J 7/00; H02J 7/02

(52) U.S. Cl. CPC D06F 79/026; H02J 7/0045; B29C 66/9141; H02J 7/0054; H02J 7/02

(57) ABSTRACT

A battery powered carpet seaming iron system includes a battery powered carpet seaming iron, a base station for receiving the battery powered carpet seaming iron, and a releasable battery pack attached to the carpet seaming iron. Power is supplied to the battery powered carpet seaming iron from either of the base station or the battery pack. The base station receives AC power from an external source and supplies power to operate the battery powered carpet seaming iron, and to charge the batteries of the battery pack. Charging power from the base station is received at the battery powered carpet seaming iron and is transmitted by the carpet seaming iron to the battery pack. The battery pack supplies power to the seaming iron for operation of the seaming iron when the seaming iron is removed from the base station.

### TECHNICAL FIELD

Embodiments described herein relate generally to providing power to a carpet seaming iron.

### SUMMARY

Embodiments described herein relate to a battery powered carpet seaming iron, and more specifically, providing power to the battery powered carpet seaming iron and charging a battery attached to the carpet seaming iron.

In one embodiment, a system is provided for powering a battery powered carpet seaming iron. The system includes a battery powered carpet seaming iron that has a handle, a battery pack interface, an iron with a heating element, a controller, and a base station interface that includes electrical connection elements. The system also includes a base station for receiving the battery powered carpet seaming iron. The base station includes an alternating current (AC) supply interface, a power supply circuit coupled to the AC supply interface, and a battery powered carpet seamer interface configured to receive the battery powered carpet seaming iron. The battery powered carpet seamer interface has a power output port coupled to the power supply circuit. The power output port has electrical connection elements configured to mate with and supply power to the electrical connection elements of the base station interface in the battery powered carpet seaming iron.

In another embodiment, a base station is provided for receiving a battery powered carpet seaming iron. The base station includes an alternating current AC supply interface, a power supply circuit coupled to the AC supply interface, and a battery powered carpet seamer interface configured to receive the battery powered carpet seaming iron. The battery powered carpet seaming iron interface of the base station includes a power output port that is coupled to the power supply circuit, and has electrical connection elements configured to mate with and supply power to electrical connection elements of a base station interface in the battery powered carpet seaming iron.

In another embodiment, a method is provided for supplying power to a battery powered carpet seaming iron. The method includes receiving by a base station, via a battery powered carpet seamer interface of the base station, the battery powered carpet seaming iron. At a power supply circuit of the base station, AC power is received via an alternating current AC supply interface. Power is supplied by the power supply circuit of the base station, via electrical connection elements of a power output port of the base station, to electrical connection elements of a base station interface of the battery powered carpet seaming iron.

Other features and aspects of the invention will become apparent by consideration of the following detailed description and accompanying drawings.

### BRIEF DESCRIPTION OF THE DRAWINGS

FIG. 1 is a view of a battery powered carpet seaming iron system, including a battery powered seaming iron with attached battery pack and base station.

FIG. 2 is a rotated view of the battery powered carpet seaming iron system described with respect to FIG. 1, including the battery powered seaming iron with attached battery pack and base station.

FIG. 3 is a view of a battery powered carpet seaming iron portion of the system described with respect to FIG. 1, including an attached battery pack.

FIG. 4 is a view of a battery powered carpet seaming iron portion of the system described with respect to FIG. 1, with battery pack removed.

FIG. 5 is a view of a base station portion of the battery powered carpet seaming iron system described with respect to FIG. 1.

FIG. 6 is a block diagram of the battery powered carpet seaming iron system described with respect to FIG. 1.

FIG. 7 is a flowchart for providing power by a base station to the battery powered carpet seaming iron system described with respect to FIG. 1, where the base station is connected to a battery powered carpet seaming iron.

FIG. 8 is a flowchart for distributing power in the battery powered carpet seaming iron system described with respect to FIG. 1, where a base station is connected with a battery powered carpet seaming iron.

FIG. 9 is a flowchart for providing power by a battery pack to a battery powered carpet seaming iron.

FIG. 10 is a flow chart for supplying power within a battery powered carpet seaming iron system under various operational conditions.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

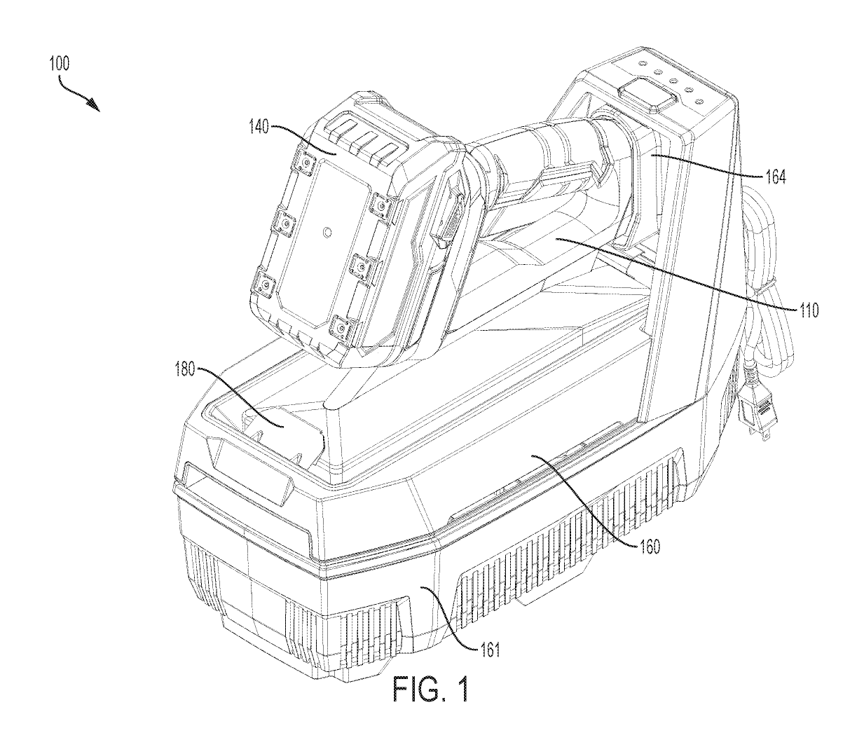

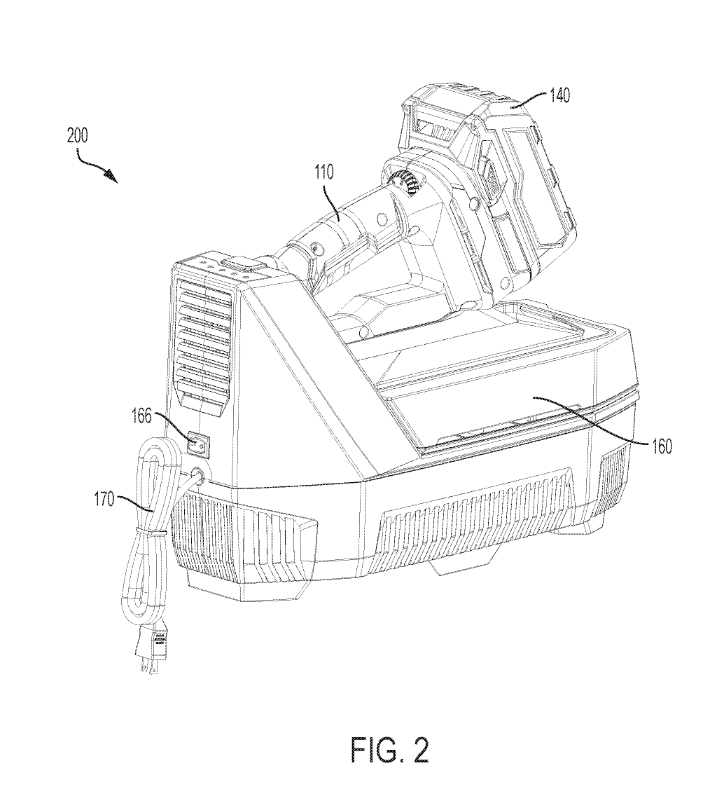

FIGS. 1-2 illustrate a battery powered carpet seaming iron system 100 that includes a battery powered carpet seaming iron 110 operatively coupled to a battery pack 140 and to a base station 160.

The base station 160 includes a battery powered carpet seamer interface 164 (also referred to as a power output port 164) that is configured to receive and electrically connect to the battery powered carpet seaming iron 110. The battery powered seaming iron 110 may be disconnected and detached from the base station 160 for operation of the seaming iron 110. The base station 160 further includes a latching mechanism 180 that secures or releases the battery powered carpet seaming iron 110 to or from the base station 160.

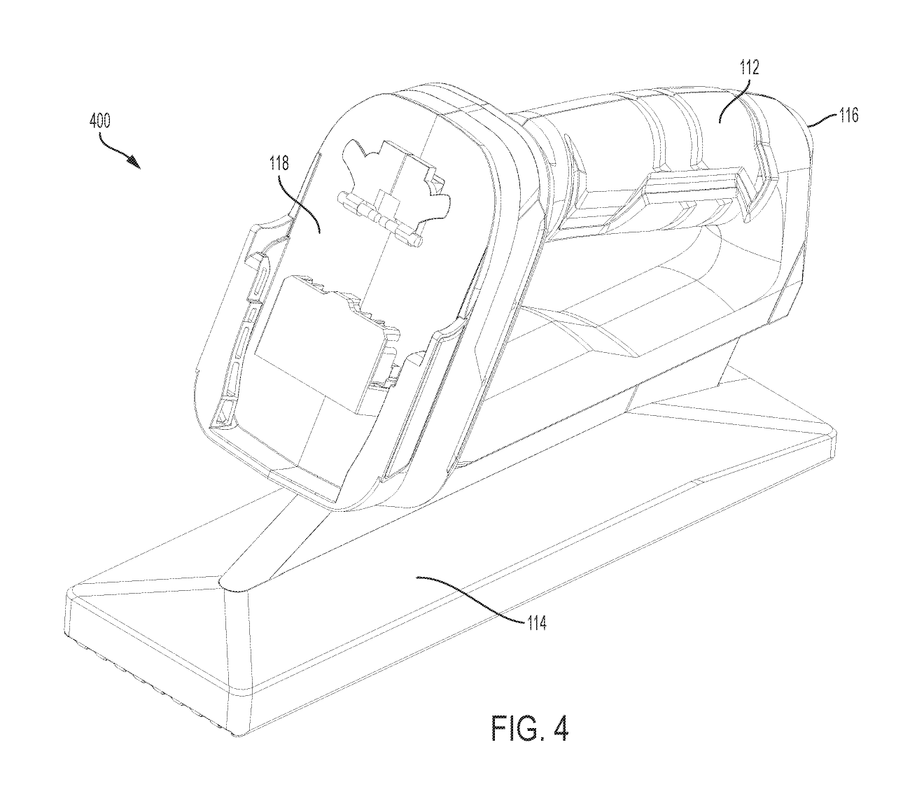

The battery powered carpet seaming iron 110 includes a battery pack interface (shown in FIG. 4) that is configured to receive and electrically connect to the battery back 140. The battery pack 140 may be disconnected and detached from the battery powered carpet seaming iron 110.

The base station 160 includes a plug and cord 170 for receiving AC power from an external power source, such as a standard 120 volt alternative current (VAC) power outlet, and an on-off switch 166 that may be controlled by a user to activate-deactivate power to the base station 160 for operation. The base station 160 is operable to provide power to the battery powered carpet seaming iron 110 for operation of the seaming iron and to charge the battery pack 140. The battery powered carpet seaming iron 110 may also be powered by the battery pack 140.

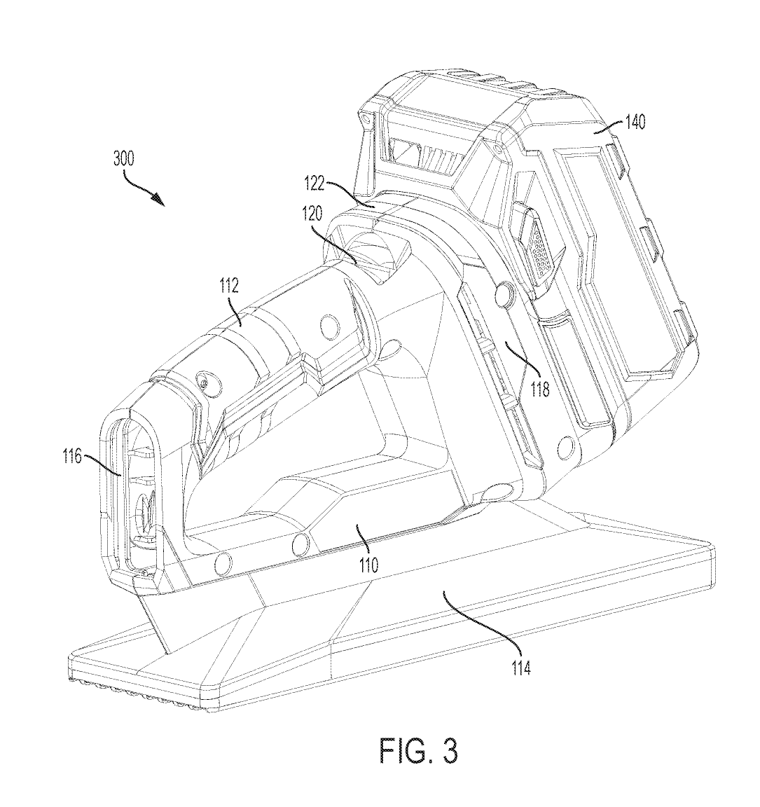

FIG. 3 is an illustration of a portion 300 of the battery powered carpet seaming iron system 100. The portion 300 includes the battery powered carpet seaming iron 110 with the battery pack 140 attached, and the base station 160 detached. This configuration may be useful when the battery powered carpet seaming iron 110 is hot and ready to use for seaming a carpet. In this regard, the battery powered carpet seaming iron 110 may be removed by a user from the base station 160 and it may continue to receive power from the battery pack 140 to operate the seaming iron 110.

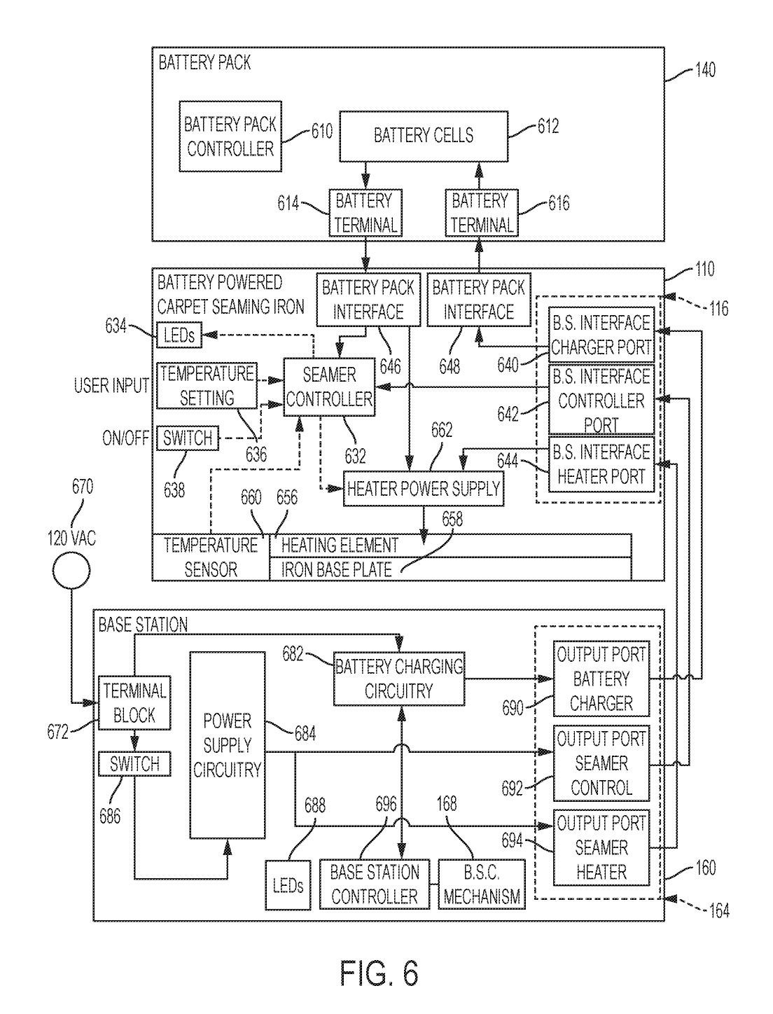

The battery powered carpet seaming 110 includes a handle 112 that is operatively attached to an iron 114. The handle 112 is configured to accept a user's hand and may be used for controlling the battery powered carpet seaming iron 110 during a carpet seaming operation. The handle 112 may be formed as part of a plastic housing. The iron 114 may include, for example, a heating element 656 and an iron base plate 658 (each shown in FIG. 6). A heat setting mechanism 120 on the handle 112 may be adjusted by a user to set a temperature or heat level for determining when to activate and when to deactivate the heating element 656 to heat the iron base plate 658 of the iron 114 to the desired heat level.

The handle 112 further includes a base station interface 116 having electrical connections for connecting to the base station 160, and a battery pack interface 118 having electrical connections for connecting to the battery pack 140. In some embodiments, the handle 112 may include one or more output indicators, for example, LEDs 122 to indicate the heating status of the heating element 656 within the iron 114.

The battery pack 140 includes battery pack terminals (not shown) that are received by, and electrically connected to, the battery pack interface 118 of the battery powered carpet seaming 110. The battery pack 140 may provide power to the battery powered carpet seaming iron 110 via the battery pack terminals, for example, when the battery powered carpet seaming iron 110 is disconnected from the base station 160 for a carpet seaming operation.

FIG. 4 is an illustration of a portion 400 of the battery powered carpet seaming iron system 100. The portion 400 includes the battery powered carpet seaming iron 110 with both of the battery pack 140 and the base station 160 detached from the seaming iron 110. Referring to FIG. 4 there is shown a rotated view relative to FIG. 3 of the base station carpet seaming iron 110 including the handle 112, the iron 114, the base station interface 116, and the battery pack interface 118, which are described with respect to FIGS. 1-3. The battery pack interface 118 may mechanically receive and electrically connect to the battery pack 140. The base station interface 116 may mechanically receive and electrically connect to the base station 160. The battery pack 140 is selectively attachable to and removable from the battery powered carpet seaming iron 110. For example, the battery pack 140 and the battery powered carpet seaming iron 110 may include physically mating features (e.g., rails and grooves) and a latching mechanism to secure the battery pack 140 to the battery powered carpet seaming iron 110 and enable selective control of the battery pack 140. Additionally, in some embodiments, the battery pack 140 is configured to attach to and power a variety of other power tools including drill drivers, impact drivers, nailers, circular saws, jig saws, reciprocating saws and other devices including work lights, radios, fans and the like.

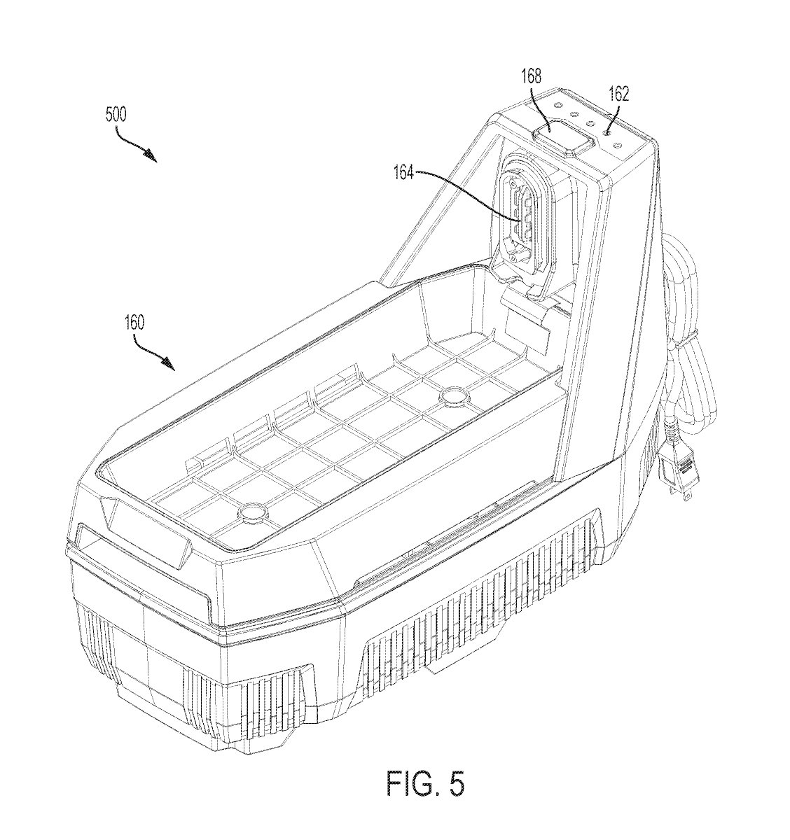

FIG. 5 is an illustration of a portion 500 of the battery powered carpet seaming iron system 100. The portion 500 includes the base station 160 where the battery powered carpet seaming iron 110 has been removed from the base station 160. The base station 160 includes a plastic housing 161 and includes the power output port 164, a charger control mechanism 168, and LEDs 162.

The power output port 165 is configured to mechanically attach and electrically connect to the base station interface 116 of the battery powered carpet seaming iron 110 when the seaming iron is placed into the base station. The base station 160 includes a receptacle sized and configured to receive and hold the iron 114 of the battery powered carpet seaming iron 110 when it is placed into the base station 160. For example, the base station 160 may include a latching mechanism 180 that secures and releases the battery powered carpet seaming iron 110. The latching mechanism 180 may enable a user to carry the entire assembly of the battery powered seaming iron system 100 by the handle 112 of the battery powered seaming iron 110 when the iron is secured to the base station.

FIG. 6 is a block diagram of a system 600 including internal elements of the battery powered carpet seaming iron system 100 that is described with respect to FIGS. 1-5. The system 600 includes the battery powered carpet seaming iron 110, the battery pack 140, and the base station 160.

The base station 160 includes a power input terminal block 672, a switch block 686, and power supply circuitry 684. The power input terminal block 672 is configured to receive input power via the plug and cord 170 from an external power source 670, for example, a standard 120 VAC power outlet. The power input terminal block 672 is coupled to and directs power to the switch block 686 and to the battery charging circuitry 682. The switch block 686 is coupled to the power input terminal block 672 and is operable to activate and deactivate VAC power to the power supply circuitry 684. The switch block 686 corresponds to the user controlled switch 166 shown in FIG. 2. The power supply circuitry 684 receives power via the switch block 686 and adapts the input power for use by various elements of the system 600. In some embodiments, the power supply circuitry 684 may include an 18 volt (V) power supply that outputs a nominal voltage of 18 volts direct current (VDC). In other embodiments, a different nominal voltage level is output by the power supply circuitry 684, such as 12 VDC, 20 VDC, or a value between 12 VDC and 24 VDC.

The base station 160 further includes the power output port 164. The power output port 164 may include electrical connections elements to mate with and direct power to electrical connection elements in the base station interface 116 (shown in FIG. 3) of the battery powered carpet seaming iron 110. For example, the electrical connection elements of the base station power output port 164 may include charger output electrical connections 690, seamer controller power output connections 692, and seamer heater power output connections 694. The connections 690, 692 and 694 respectively mate with and supply power to electrical connection elements of the seaming iron base station interface 116, which may include a charger power input 640, a seamer controller power input 642, and a seamer heater power input 644.

The base station 160 further includes battery charging circuitry 682 that may receive power via the power input terminal block 672 and provide charging power for the battery cells 612 of the battery pack 140. In some embodiments, the battery charging circuitry 682 may include a RIDGID® X5 battery charger. The battery charging circuitry 682 may direct the charging power to the battery powered carpet seaming iron 110 via the charger output electrical connections 690 of the power output port 164.

In addition, the base station 160 has a base station controller 696 including an electronic processor that may drive multiple modes of operation for supplying power to the battery powered carpet seaming iron 110. The base station controller 696 may be coupled to the base station control mechanism 698, and may be responsive to user input via the base station control mechanism 698. The base station controller 696 may be communicatively coupled to output indicators such as the LEDs 688 to indicate, for example, when the battery charging circuitry 682 is providing charging power, when a charge is complete and the charging circuitry 682 is in a maintenance mode, or when the charging circuitry 682 is in an energy saving mode.

The battery powered carpet seaming iron 110 includes a seamer controller 632 that manages operations on the carpet seaming iron 110, and a heater power supply 662 that is coupled to and supplies power to the heating element 656.

The battery powered carpet seaming iron 110 further includes electrical connection elements in the base station interface 116 that may include the charger power input 640, the seamer controller power input 642, and the seamer heater power input 644 for connecting with the electrical connections in the power output port 164 of the base station 160. Within the battery powered carpet seaming iron 110, the seamer controller power input 642 is coupled to and directs power to the seamer controller 632. The heater power input 644 is coupled to and directs power to the heater power supply 662, which is coupled to and directs power to the heating element 656.

Moreover, the battery powered carpet seaming iron 110 includes battery pack interfaces 646 and 648 that have electrical connection elements for connecting, respectively, to battery terminals 614 and 616 within the battery pack 140. In order to direct charging power from the base station 160 via the battery powered carpet seaming iron 110 to the battery pack 140, the charger power input 640 is coupled to the battery pack interface 646, which may be mated with the battery terminal 616 in the battery pack. Also, the battery pack interface 646 may receive power from the battery pack 140 and direct the power to the seamer controller 632 and the heater power supply 662. In some embodiments, the battery pack interfaces 646 and 648 are combined into a battery pack interface with at least some share terminals.

The seamer controller 632 includes an electronic processor that controls carpet seamer operations and is communicatively coupled to LEDs 634, a user controlled temperature setting mechanism 636, a seamer on-off switch 638, a temperature sensor 660, and the heater power supply 662, each part of the battery powered carpet seaming iron 110.

The battery pack 140 provides power to the battery powered carpet seaming iron 110, for example, when the seaming iron 110 is disconnected from the base station 160. The battery pack 140 includes battery cells 612, a battery pack controller 610, and the battery terminals 614 and 616 that respectively mate with the battery pack interfaces 646 and 648 of the battery powered carpet seaming iron 110. The battery pack controller 610 includes an electronic processor and may be operable to sense charge levels and/or temperature levels in the battery cells 612 and may communicate the charge status to the battery powered carpet seaming iron 110 and/or the base station 160, or may signal when to begin or end charging. The battery pack controller 610 is further configured to control discharge at the battery cells 612.

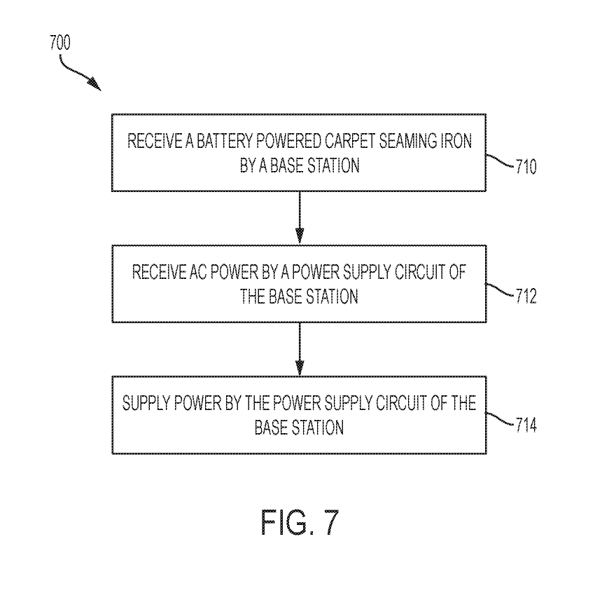

FIG. 7 illustrates a method 700 for providing power by a base station to battery powered carpet seaming iron system when the battery powered carpet seaming iron is connected to the base station. The method 700 is described with respect to the system 100 but, in some embodiments, is applicable to other systems.

Referring to FIG. 7, in step 710, the base station 160 receives and electrically connects with the battery powered carpet seaming iron 110. For example, electrical connection elements in the power output port 164 of the base station 160 may be connected to electrical connection elements in the base station interface 116 of the battery powered carpet seaming iron 110. FIGS. 1-2 illustrate the battery powered carpet seaming iron 110 and the base station 160 in such a configuration. The battery pack 140 may or may not be attached to the battery powered carpet seaming iron 110 when the iron 110 is received by the base station 160.

In step 712, the power supply circuit 684 of the base station 160 receives power input. For example, the power supply circuitry 684 may receive AC power from a standard supply, such as a 120 VAC power outlet via the plug and cord 170 and the power input terminal block 672. In some embodiments, the user controlled switch 686 may enable and disable the power input to the power supply circuitry 684 based on toggling of the on-off switch 686.

In step 714, power is supplied by the base station 160 to the battery powered carpet seam iron 110 via the power output ports 164 and the seamer iron base station interface 116. More particularly, the base station 160 provides power via one or more of the connections 690, 692 and 694 to one or more of the respectively coupled inputs 640, 642 and 644 of the battery powered carpet seaming iron 110. For example, the base station 160 may supply power to perform one or more of operating the seamer controller 632 of the carpet seaming iron 110, heating the carpet seaming iron heating element 656, and charging the battery cells 612 in the battery pack 140.

The power supply circuitry 684 adapts the AC input power and provides power to the various elements of the battery powered carpet seaming iron system 600, for example, the heating element 656, and the seamer controller 632. The power supply circuitry 684 may rectify the received AC power to output DC power, and may further convert and filter the DC power to provide DC power at appropriate levels for various components of the system 600. The charging circuitry 682 may receive power from the power input terminal block 672 and may adapt the input power for supplying charging power to the battery cells 612. The power output from the battery charging circuit 682 and the power supply circuit 684 may be distributed to the respective system 600 elements via the power output port 164 of the base station 160. The adapted power is also provided to other powered elements of the base station, including the base station controller 696 and the LEDs 688.

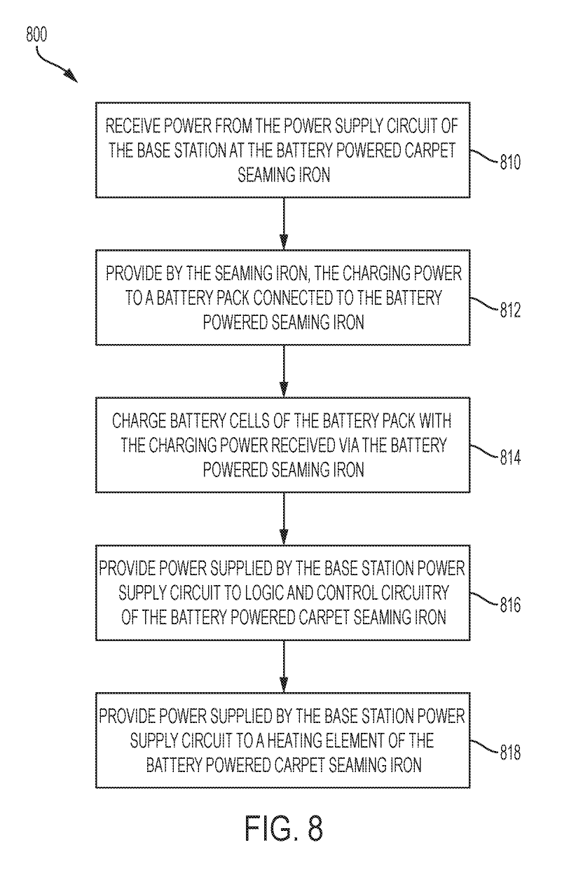

FIG. 8 illustrates a method for receiving power in a battery powered carpet seaming iron when the carpet seaming iron is connected with a base station. The method 800 is described with respect to the system 100 but, in some embodiments, is applicable to other systems. In some embodiments, the method 800 is performed in combination with the method 700. For example, step 810 may be executed after or with step 714.

Referring to FIG. 8, in step 810, the battery powered carpet seaming iron 110 receives power from the power supply circuitry 684 of the base station 160. The power is received at the electrical connection elements in the base station interface 116 from the electrical connection elements in the power output port 164 of the base station 160. The battery powered carpet seaming iron 110 also receives power from the battery charging circuit 682 and forwards the power to the battery pack 140.

In step 812, the battery powered carpet seaming iron 110 directs battery charging power received from the base station 160 to the battery pack 140. In this regard, the battery charging power may be directed from the base station interface 116 via the carpet seamer battery pack interface 648, to the battery terminals 616 of the battery pack 140 and to the battery cells 612.

In step 814, the battery cells 612 of the battery pack 140 are charged by the battery charging power received from the base station 160 via the battery powered carpet seaming iron 110. In some embodiments, the battery pack controller 610 may monitor the level of charge in the battery cells 612 and may communicate with the base station controller 696 via the battery powered carpet seaming iron 110 to control a battery charging process by the battery charging circuitry 682. The battery charging circuitry 682 may then provide the battery charging power to the seaming iron 110 for application to the battery cells 612.

In step 816, power supplied by the base station 160 may be directed to the seamer controller 632 of the battery powered carpet seaming iron 110. For example, the seamer controller 632 may be activated when the on-off switch 638 is activated by a user. Power from the base station 160 may be directed to the seamer controller 632 from the base station interface 116 via the connection 692 and the inputs 642.

In some embodiments the seamer controller 632 may be operable to determine user input temperature settings from the temperature setting mechanism 636, and may determine heat levels of the iron base plate 658 from the temperature sensor 660. The seamer controller 632 may responsively control the heater power supply 662 to provide power to the heating element 656 and heat the iron base plate 658. For example, the seamer controller 632 determines the temperature of the iron base plate 658 from the temperature sensor 660, compares the temperature to a desired temperature or a threshold set by the temperature setting mechanism 636, and controls power to the heating element 656 to raise or lower the temperature of the iron base plate 658 based on the comparison, to be at or near the desired temperature threshold. The seamer controller 632 may activate the LEDs 634 to indicate the status of the battery powered carpet seaming 110, for example, to indicate when the temperature of the carpet seaming iron is ready for use to seam a carpet.

Furthermore, the seamer controller 632 may control the supply of charging power to the battery pack 140 based on communication from the battery pack controller 610, and may communicate with the base station controller 696 to control output of the battery charging circuitry 682 for direction to the battery pack 140. The communication may occur via one or more of the battery pack interfaces 646, 648 and the base station interface 116, either over additional terminals within these interfaces or time multiplexed terminals of the interfaces.

In step 818, power from the base station 160 may be directed to the heater power supply 662 in order to activate the heating element 656 and heat the iron base plate 658. For example, power received from the base station 160 may be directed from the base station interface heater port 644 to the heater power supply 662. In some embodiments, activation of the heating element 656 may be enabled when the battery powered carpet seaming iron switch 638 is activated by a user, and triggered when the temperature sensor 660 indicates that the iron base plate 658 does not have a specified heat level for performing a carpet seaming procedure.

In some embodiments of the method 800, steps 812 and 814 are bypassed. For example, when the battery pack 140 is not coupled to the battery powered carpet seaming iron 110, the charging-related steps 812 and 814 are bypassed and the method 800 proceeds from step 810 to step 816. The seamer controller 632 may be configured to determine whether the battery pack 140 is coupled to the battery powered carpet seaming iron 110 and, in response, control whether the steps 812 and 814 are executed or bypassed. In some embodiments, step 816, step 818, or both, are bypassed dependent on the state of the on-off switch 638. For example, when the on-off switch 638 is in an off-state, the seamer controller 632 may bypass one or more of the steps 816 and 818. To execute or bypass one of the steps 812 or 814, the seamer controller 632 may respectively open or close a switch (not shown) of the input 640 or interface 648. To execute the step 816, the on-off switch 638 may open a current path between the input 642 and the seamer controller 632, or with respect to the supplying charging power to the battery pack, the seamer controller 632 may control a switch (not shown) of the input 640 to open the current path. To bypass step 818, the seamer controller 632 may control the heater power supply 662 to not supply power to the heating element 656.

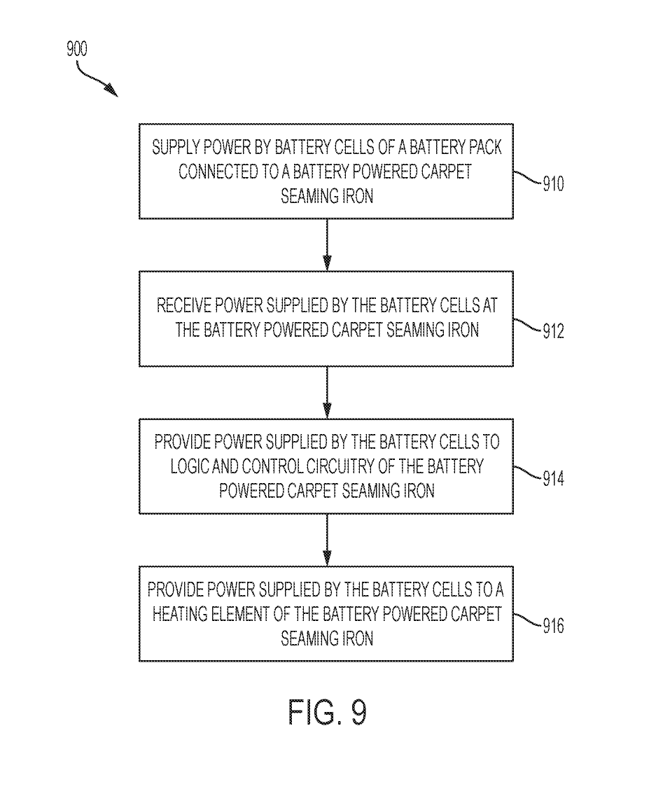

FIG. 9 is a flowchart for providing power by a battery pack to a battery powered carpet seaming iron. For example, the battery pack may supply power to the battery powered carpet seaming iron when the carpet seaming iron is disconnected from a base station. In some embodiments, the method 900 is performed in combination with the methods 700 and 800. The method 900 is described with respect to the system 100 but, in some embodiments, is applicable to other systems.

Referring to FIG. 9, in step 910, battery cells 612 of the battery pack 140 supply power to the battery powered carpet seaming iron 110. For example, when the battery pack 140 is connected to the battery powered carpet seaming iron 110, power from the battery cells 612 may be provided to the battery pack interface 646 of the battery powered carpet seaming iron 110 via the battery terminals 614.

In step 912, the battery powered carpet seaming iron 110 receives power from the battery cells 612 at the battery pack interface 646. For example, the power received from the battery cells 612 may be received at the battery pack interface 646.

In step 914, power supplied by the battery cells 612 to the battery pack interface 646 may be directed to the seamer controller 632 of the battery powered carpet seaming iron 110.

The seamer controller 632 may be operable to determine user temperature settings and heat levels of the iron base plate 658, for example, from the user temperature setting mechanism 636 and the temperature sensor 660, and responsively control the heater power supply 662 to provide power to the heating element 656 and thus heat the iron base plate 658. The seamer controller 632 may also activate the LEDs 634 to indicate a status of the battery powered carpet seaming 110, for example, to indicate when the temperature of the carpet seaming iron is ready for seaming a carpet.

In step 916, power from the battery cells 612 may be directed to the heater power supply 662 from the battery pack interface 646. For example, power received from the battery pack 140 via the battery pack interface 646 may be directed to the heater power supply 662, which may provide power to the heating element 656 for heating the iron base plate 658. In some embodiments, activation of the heating element 656 may be enabled when the battery powered carpet seaming iron switch 638 is turned on by a user, and a heating process may be triggered when the temperature sensor 660 indicates that the iron base plate 658 does not have adequate heat for performing a carpet seaming procedure or when the sensed temperature is below a desired temperature threshold set by the temperature setting mechanism 636.

In some embodiments, for example, when the iron base plate 658 is cold or has cooled down and the battery powered carpet seaming iron 110 is connected to the base station 160, the power supply circuitry 684 of the base station 160 may provide power to the heating element 656 until the temperature of the iron base plate 658 reaches a specified level and/or it is removed from the base station 160. Once the battery powered carpet seaming iron 110 is disconnected from the base station 160 (for example when it is in use to seam a carpet), the battery pack 140 may begin to supply power to the heating element 656 as well as to other circuitry on the battery powered carpet seaming iron 110, to maintain proper heat levels for seaming the carpet. Accordingly, in this scenario, the base station 160 is configured to provide power to pre-heat the iron base plate 658, while the battery pack 140 is used to maintain the desired temperature of the iron base plate 658. Such an arrangement uses less power from the battery pack 140 than an example in which the battery powered carpet seaming iron 110 is powered solely by the battery pack 140 from an initial cool state to the desired temperature. The battery powered carpet seaming iron 110 is able to be used for an extended period of time before the battery pack 140 is depleted and should be recharged or replaced with a charged battery pack.

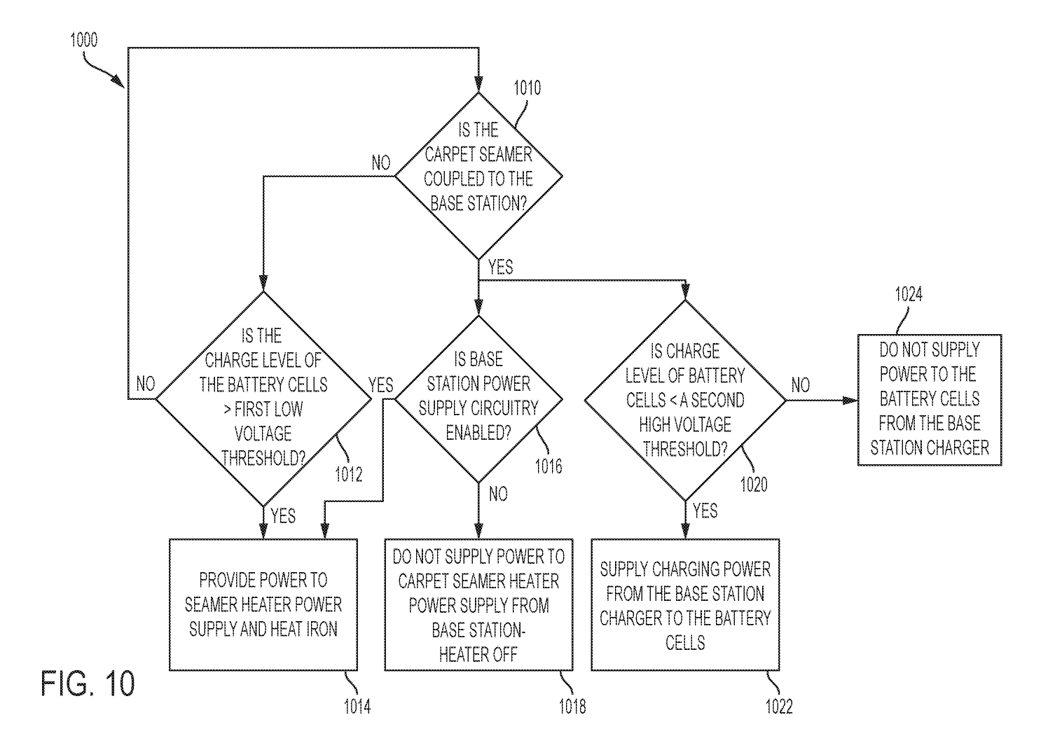

FIG. 10 illustrates a method for supplying power within a battery powered carpet seaming iron system. The method 1000 is described with respect to the system 100, but in some embodiments, is applicable to other systems. In some embodiments, the method 1000 is performed in combination with the methods describe in FIGS. 7, 8 and 9. Additionally, in the description of the method 1000 that follows, a controller is described as performing various actions. In this context, the controller may be one or both of the base station controller 696 and the seamer controller 632, acting independently or together.

Referring to FIG. 10, in step 1010, a controller, such as the base station controller 696 or the seamer controller 632, determines whether the battery powered carpet seaming iron 110 is coupled to the base station 160. For example, the base station controller 696, the seamer controller 632, or both, monitor one or more of the base station interface 116 and the power output port 164 for electrical signals that are indicative of the base station 160 being coupled to the battery powered carpet seaming iron 110. Alternatively, a switch or device sensor that are triggered upon coupling the base station 160 to the battery powered carpet seaming iron 110 is in communication with one or more of the base station controller 696 and the seaming controller 632. From the output of the switch or device sensor, one or more of the base station controller 696 and the seaming controller 632 determines whether the battery powered carpet seaming iron 110 is coupled to the base station 160.

When the controller determines that the battery powered carpet seaming iron 110 is not coupled to the base station 160, the controller proceeds to step 1012. In step 1012, the controller determines whether charge in the battery pack 140 is above a first (low) voltage threshold. For example, in some embodiments, the seamer controller 632 senses a voltage level of the battery pack at the battery terminal 614 or the battery pack controller 610 may communicate the voltage level to the seamer controller 632, where the voltage level is proportional or indicative of the charge level of the battery pack 140. The seamer controller 632 then determines the charge level from the voltage level, and compares the determined charge level of the battery pack 140 to the first voltage threshold. When a charge level in the battery cells 612 is above the first voltage threshold, the controller proceeds to step 1014. In step 1014, the seamer controller 632 controls power from the battery cells 612 to be supplied, via the battery terminal 614, to the battery pack interface 646 of the battery powered carpet seaming iron 110, and further to the heater power supply 662, and the heating element 656 to heat the base plate 658. In other words, in step 1014, the power from the battery pack 140 may be used to power the carpet seaming iron 110 above with respect to method 900.

In step 1012, in instances when the charge in the battery cells 612 is determined to not be above the first voltage threshold, the controller returns to step 1010. In step 1010, in instances when the controller determines that the battery powered carpet seaming iron 110 is coupled to the base station 160, the controller proceeds to step 1016. In step 1016, the controller determines whether the power supply circuitry 684 is enabled. For example, controller determines whether the power supply circuitry 684 is enabled when the switch 686 is turned-on and the power input terminal block 672 is coupled to the external power source 670. In instances when the power supply circuitry 684 is enabled, the controller proceeds to step 1014, which is discussed above.

In step 1016, when the controller determines that the power supply circuitry 684 is not enabled (for example, when the switch 686 is turned-off or the power input terminal block 672 is not coupled to the external power source 670), the controller proceeds to step 1018 and controls the heater power supply 662 to not provide power to the heating element 656. In other words, in step 1018, the heater power supply 662 does not receive power from the battery pack 140 or from the base station 160.

In step 1010, in instances when the controller determines that the battery powered carpet seaming iron 110 is coupled to the base station 160, the controller also proceeds to step 1020 in addition to step 1016. In some embodiments, the steps 1016 and 1020 are performed in parallel or in an overlapping manner. However, in some embodiments, the steps 1016 and 1020 are performed serially.

In step 1020, the controller determines whether the voltage of the battery pack 140 is below a second (full battery) voltage threshold. For example, the base station controller 696 senses the voltage level via the charger output electrical connection 690 connected to the battery terminal 614 (via the battery powered carpet seaming iron 110) or is informed of the voltage level from the battery pack controller 610 or the seamer controller 632 via a data connection of the base station interface 116 and the power output port 164. The base station controller 696 then compares the voltage level to the second battery threshold to determine whether the voltage of the battery pack 140 is below the second voltage threshold. When the base station controller 696 determines that the voltage of the battery pack 140 is below the second voltage threshold, the battery charging circuit 682 proceeds to step 1022.

In step 1022, the base station 160 charges the battery cells 612 in the battery pack 140 by supplying power from the power supply circuitry 684 to the battery charging circuitry 681, and from the battery charging circuitry 681 via the battery charger output connection 690 to the base station interface charger port 640 in the battery powered carpet seaming iron 110. The power is further transmitted from the base station interface charger port 640, via the battery pack interface 648, to the battery terminal 616 in the battery pack 140, and further to the battery cells 612.

In step 1020, when the controller determines that the voltage of the battery pack 140 is above the second voltage threshold, the controller proceeds to step 1024. In step 1024, the base station 160 may stop charging the battery cells 612. Although not illustrated, after executing or beginning to execute each of step 1014, 1018, 1022, and 1024 in the illustrated flow chart of FIG. 10, the method may return to step 1010 such that the method 1000 is a control loop.

The controllers described herein are electronic controllers and may be configured to carry out the functionality attributed thereto via execution of instructions stored on a computer readable medium, via hardware circuits (e.g., an application specific integrated circuit (ASIC) or field programmable gate array) configured to perform the functions, or a combination thereof. For example, the controllers 696, 632 and 610 may include an electronic processor coupled to a memory storing instructions that are retrieved and executed by the electronic processor to carry out the functionality attributable thereto as described herein.

Although the invention has been described in detail with reference to certain preferred embodiments, variations and modifications exist within the scope and spirit of one or more independent aspects of the invention as described.

What is claimed is:

1. A system for powering a battery powered carpet seaming iron, the system comprising:
a battery powered carpet seaming iron including:
a handle,
a battery pack interface,
an iron with a heating element,
an electronic seamer controller, and
a base station interface including electrical connection elements; and
a base station for receiving the battery powered carpet seaming iron, the base station comprising:
an alternating current (AC) supply interface;
a power supply circuit coupled to the AC supply interface;
a battery powered carpet seamer interface configured to receive the battery powered carpet seaming iron and including:
a power output port coupled to the power supply circuit and having electrical connection elements configured to mate with and supply power to the electrical connection elements of the base station interface in the battery powered carpet seaming iron.

2. The system of claim 1 further comprising a battery pack for powering the battery powered carpet seaming iron, the battery pack comprising:
an electronic battery controller,
battery cells, and
battery terminals comprising electrical connection elements configured to mate with, supply power to, and receive charging power from electrical connection elements of the battery pack interface of the battery powered carpet seaming iron, the battery pack being detachably coupled to the battery powered carpet seaming iron.

3. The system of claim 2 further comprising a battery charging circuitry within the base station for charging the battery cells in the battery pack, wherein the battery charging circuitry is configured to supply charging power to the battery cells of the battery pack via the power output port of the base station, the base station interface of the battery powered carpet seaming iron, the battery pack interface of the battery powered seaming iron, and the battery terminals of the battery pack.

4. The system of claim 1, wherein the power supply circuit is configured to supply power to the battery powered carpet seaming iron from the base station when the battery powered carpet seaming iron is connected to the base station and the battery pack is configured to supply power to the battery powered carpet seaming iron when the battery powered carpet seaming iron is disconnected from the base station.

5. The system of claim 1, wherein the battery pack is configured to supply power to the electronic seamer controller of the battery powered carpet seaming iron via electrical connection elements in the battery pack interface of the battery powered carpet seaming iron in a first instance, and the power supply circuit of the base station is configured to supply power to the electronic seamer controller of the battery powered carpet seaming iron via the electrical connection elements in the base station interface of the battery powered carpet seaming iron in a second instance.

6. The system of claim 1, wherein the battery pack is configured to supply power to the heating element of the battery powered carpet seaming iron via the electrical connection elements in the battery pack interface of the battery powered carpet seaming iron in a first instance, and the power supply circuit of the base station is configured to supply power to the heating element of the battery powered carpet seaming iron via the electrical connection elements in the base station interface of the battery powered carpet seaming iron in a second instance.

7. A base station for receiving a battery powered carpet seaming iron, the base station comprising:
an alternating current (AC) supply interface;
a power supply circuit coupled to the AC supply interface;
a battery powered carpet seamer interface configured to receive the battery powered carpet seaming iron and including:
a power output port coupled to the power supply circuit and having electrical connection elements configured to mate with and supply power to electrical connection elements of a base station interface of the battery powered carpet seaming iron.

8. The base station of claim 7 further comprising:
battery charging circuitry coupled to the AC supply interface and coupled to two or more of the electrical connection elements of the power output port.

9. The base station of claim 8, wherein the battery charging circuitry of the base station is operable to supply power to electrical connection elements of the base station interface of the battery powered carpet seaming iron via the two or more electrical connection elements of the power output port for charging a battery pack that is electrically coupled to the battery powered carpet seaming iron.

10. The base station of claim 7, wherein the power supply circuit is operable to supply power to electrical connection elements of the base station interface of the battery powered carpet seaming iron via another two or more electrical connection elements of the power output port for heating a heating element of the battery powered carpet seaming iron.

11. The base station of claim 7, wherein the power supply circuit is operable to supply power to electrical connection elements of the base station interface of the battery powered carpet seaming iron via further two or more electrical connection elements of the power output port for supplying power to a electronic seamer controller of the battery powered carpet seaming iron.

12. A method for supplying power to a battery powered carpet seaming iron, the method comprising:
receiving by a base station, via a battery powered carpet seamer interface of the base station, the battery powered carpet seaming iron;
receiving, at a power supply circuit of the base station via an alternating current (AC) supply interface, AC power; and
supplying power, by the power supply circuit of the base station, to electrical connection elements of a base station interface of the battery powered carpet seaming iron via electrical connection elements of a power output port of the base station.

13. The method of claim 12, wherein supplying power by the power supply circuit of the base station further comprises:
receiving, by a charging circuit of the base station, power from the AC supply interface of the base station; and
transmitting charging power to the electrical connection elements of the base station interface of the battery powered carpet seaming iron via electrical connection elements of the power output port of the base station.

14. The method of claim 13 further comprising:
receiving the charging power, by the battery powered carpet seaming iron, via the electrical connection elements of the base station interface of the battery powered carpet seaming iron; and
providing the charging power, by the battery powered carpet seaming iron, to electrical connection elements of battery terminals of a battery pack coupled to the battery powered carpet seaming iron via electrical connection elements of a battery pack interface of the battery powered carpet seaming iron to charge battery cells of the battery pack.

15. The method of claim 12, wherein supplying power by the power supply circuit of the base station further comprises:
receiving, by a charging circuit of the base station, power from the AC supply interface;
transmitting charging power to the electrical connection elements of the base station interface of the battery powered carpet seaming iron via electrical connection elements of the power output port of the base station; and
providing the charging power, by the battery powered carpet seaming iron, to a battery pack coupled to the battery powered carpet seaming iron to charge the battery pack.

16. The method of claim 12 further comprising:
providing by the battery powered carpet seaming iron, the power supplied by the base station to an electronic controller in the battery powered carpet seaming iron.

17. The method of claim 12 further comprising:
providing, by the battery powered carpet seaming iron, the power supplied by the base station to a heating element in the battery powered carpet seaming iron.

18. The method of claim 17 further comprising:
providing, by the battery powered carpet seaming iron, the power supplied by the base station to a battery pack coupled to the battery powered carpet seaming iron to charge the battery pack in parallel with providing the power supplied by the base station to the heating element in the battery powered carpet seaming iron.

19. The method of claim 12, further comprising:
entering, by the battery powered carpet seaming iron, a disconnected state in which the battery powered carpet seaming iron is disconnected from the base station:
supplying power, by battery cells of a battery pack connected to the battery powered seaming iron, to electrical connection elements in a battery pack interface of the battery powered carpet seaming iron via electrical connection elements of battery terminals of the battery pack.

20. The method of claim 19, further comprising:
providing, by the battery powered carpet seaming iron, the power supplied by the battery pack to an electronic controller in the battery powered carpet seaming iron; and
providing, by the battery powered carpet seaming iron, the power supplied by the battery pack to a heating element in the battery powered carpet seaming iron.
